(19) United States
(12) Patent Application Publication
(10) Pub. No.: US 2015/0237400 A1
(43) Pub. Date: Aug. 20, 2015

(54) SECURED FILE DISTRIBUTION SYSTEM AND METHOD

(71) Applicants: Benedict Ow, Las Vegas, NV (US); Andrew Platter, Vista, CA (US); Dmitry Kogosov, Henderson, NV (US); Richard Stiles, Henderson, NV (US)

(72) Inventors: Benedict Ow, Las Vegas, NV (US); Andrew Platter, Vista, CA (US); Dmitry Kogosov, Henderson, NV (US); Richard Stiles, Henderson, NV (US)

(21) Appl. No.: 14/701,830

(22) Filed: May 1, 2015

Related U.S. Application Data
(63) Continuation-in-part of application No. 13/865,908, filed on Apr. 18, 2013, now Pat. No. 9,027,050.
(60) Provisional application No. 61/749,305, filed on Jan. 5, 2013.

(51) Int. Cl. H04N 21/4627; H04N 21/436; H04N 21/254

(52) U.S. Cl. CPC H04N 21/4627; H04N 21/2541; H04N 21/43615

(57) ABSTRACT

A media distribution system provides controlled distribution of media owned by various parties hosted on a local media access device. A dynamic multiple assignable partition provides management features to govern access and usage of storage devices such as hard drives, flash drives, logical drives and other repositories that store and manage digital content. The storage devices can be assigned to a single user, or to a group of users, and can be configured to provide specific permissions to each user or group, governing their access and other permissions.

### CROSS-REFERENCE TO RELATED APPLICATION

This application is a continuation-in-part of U.S. patent application Ser. No. 13/865,908, filed Apr. 18, 2013, which claims priority to U.S. Provisional Patent Application No. 61/749,305, filed Jan. 5, 2013.

### BACKGROUND OF THE INVENTION

1. Field of the Invention

The invention relates to distribution and storage of digital media, and in particular to a secured file distribution system and method therefor.

2. Related Art

The devices, features, and functions described herein are intended to address the movie and media delivery marketplace. There are currently a number of movie and media delivery systems available that provide users the capability to stream movies online to their TVs, PCs, and portable smart devices.

From the discussion that follows, it will become apparent that the present invention addresses the deficiencies associated with the prior art while providing numerous additional advantages and benefits not contemplated or possible with prior art constructions.

### SUMMARY OF THE INVENTION

A media distribution system comprising a file access device is disclosed herein. The media distribution system herein provides an alternative to traditional media delivery methodologies while enhancing the usability of the media or other files in low bandwidth market and service areas.

In general, the media access device allows users to store and share digital media locally. It is noted that media may comprise files of various types, including audio, video, text, image or other files in various file formats. In this manner, the media access device eliminates the need to store media, such as rental media, on remote online storage devices or cloud storage devices. The media access device also allows temporary storage and management of media that is being leased or rented from a third party media provider. The media access device provides separate and secure storage for rental media to ensure media security.

As will become apparent from the disclosure herein the media access device of the media distribution system herein may have a variety of configurations. For instance in one exemplary embodiment a media access device may comprise one or more communication devices configured to receive rented or purchased media from a media provider at one or more predefined times, and a storage device having at least one provider managed partition and at least one user managed partition where the rented or purchased media is stored in the provider managed partition while user media is stored in the user managed partition.

The predefined times may be received from (i.e., scheduled by) the user. In addition, the rented or purchased media may be encrypted prior to its storage in the provider managed partition.

The media access device may also include one or more output terminals configured to transmit media from the storage device to one or more client devices for presentation, and a processor configured to receive one or more instructions from the media provider, where the instructions defining use and access restrictions for the rented or purchased media.

Typically, the media provider remotely controls addition and removal of the rented or purchased media in the provider managed portion, while the user controls addition and removal of media in the user managed portion. A communication device may be provided to communicate with the media provider via a wide area network. In addition or alternatively, a communication device may be provided to communicate with the user via a local area network. It is noted that the client devices may be televisions, smartphones, tables, laptop or desktop personal computers, or other computing or display devices capable of presenting media to a user.

The media distribution system may have various configurations as well. For example, in one embodiment, a media distribution system may comprise a media provider configured to distribute rented or purchased media, and a media access device. The media access device may comprise provider managed storage configured to store the rented or purchased media, user managed storage configured to store user media, wherein the provider managed storage and user managed storage are separate, and one or more communication devices configured to receive the rented or purchased media from the media provider via at least one wide area network.

A processor configured to receive one or more instructions from the media provider is included as well, with the instructions defining use and access restrictions for the rented or purchased media. Similar to above, the media provider remotely controls addition and removal of the rented or purchased media in the provider managed storage, while the user controls addition and removal of user media in the user managed storage.

The user may control addition and removal of the user media via a client device in communication with the media access device. An output device may be included to transmit the rented or purchased media and the user media to a client device for presentation. It is contemplated that the output device may be a wired or wireless network interface.

The media access device may receive the rented or purchased media at one or more times defined (i.e., scheduled) by the user. In addition, the rented or purchased media may be encrypted before it is stored in the provider managed storage. The provider managed storage and the user managed storage may be different storage partitions on one or more storage devices.

Various methods for distributing media are disclosed herein as well. For instance, in one exemplary embodiment a method for providing media with a media access device is disclosed. Such a method may comprise receiving media at the media access device, determining if the media is provider media or user media, and storing provider media in a provider media partition and storing user media in a user media partition with the provider media partition and the user media partition being separate partitions. The provider media may be encrypted on the provider media partition.

The method also includes adding or removing the provider media based on one or more instructions from a media provider, and adding or removing the user media based on one or more instructions from a user. Access to the provider media is provided based on use and access restrictions defined by the media provider. However, the media provider does not control the user media.

The provider media or user media will typically be transmitted to a client device for presentation to the user. It is noted that the instructions from the media provider may be received from a wide area network while the instructions from the user are received from a local area network. In addition, if the media is provider media, the media may be received only at one or more predetermined times defined by the user. In general, the provider media is rented or purchased from the media provider by the user.

The Secured Media Distribution System additionally provides a method for creating; assigning and administrating storage repositories for user owned digital storage. The Dynamic Multiple Assignable Partition (DMAP) system enables the device owner to manage the assignment and partitioning of the user owned storage, as well as managing the use of any external (wired or wireless) storage connected to the Secured Media Distribution System.

In general, digital content (such as files, folders, images, videos and other data) is stored on a medium such as a hard drive, wherein the hard drive is generally utilized by a single user, as is the case in a normal PC type environment. The DMAP method provides a system and method to allow a storage repository (such as a hard drive) to be partitioned multiple times and with multiple configurations to allow one or more parties to utilize the storage repository.

As will become apparent from the disclosure herein the DMAP may have a variety of configurations. For instance in one exemplary embodiment, the DMAP may be utilized to create and administrate separate storage repositories on a hard drive to enable a user managed partition to operate separately and independently from a provider managed partition for storage of digital content within a secured media distribution system.

The DMAP may be utilized by the secured media distribution system provisioner to ensure the security and integrity of the digital content stored within each partition. Moreover, these partitions can be managed and redefined, even after the initial partition assignment has taken place.

In another preferred embodiment, the DMAP may be used to assign external storage repositories (USB hard drives, thumb drives or existing partitions on other devices) to be utilized by a specific person or party.

As an example, a digital content owner can attach multiple (USB or wireless type) external hard drives to the secured media distribution system. The digital content owner can then utilize the DMAP to assign each external drive to a different user. During provisioning, the digital content owner can choose the level of interaction with their assigned drive and/or other drives he wishes to assign to the recipient of the assigned drive. As an example, the digital content owner may provision and assign an external drive to a secondary user, but limit that user to a “view only” type interaction with the drive. Or, the digital content owner may assign an external drive to a secondary user and give them full upload, download and access permissions to the assigned drive.

The DMAP may be deployed independently of the Secured Media Distribution System, as a component of another system. For example, in one embodiment, the DMAP may be deployed as part of a home LAN within a Network Attached Storage Device (NAS), wherein the NAS can be partitioned by the DMAP to allow more than one user to access the storage associated with the device. The storage internal to the NAS device may be partitioned to create separate storage repositories for each user, or groups of users. External storage devices connected to the NAS can also be controlled, assigned and provisioned by the NAS owner/administrator utilizing the DMAP.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating handling of media, including rights and ownership, via an exemplary media distribution system;

FIG. 2A is a block diagram illustrating an exemplary media distribution system and environment of use;

FIG. 2B is a block diagram illustrating an exemplary media distribution system and components thereof in an exemplary environment of use;

FIG. 2C is a block diagram illustrating an exemplary media distribution system and components thereof in an exemplary environment of use;

FIG. 3 is a diagram illustrating the primary components of the DMAP system;

FIG. 4 is a diagram illustrating a typical configuration menu for assignment and partitioning of storage repositories within the DMAP system;

FIG. 5 is a diagram illustrating the assignment of storage space within the DMAP system; and

FIG. 6 is a diagram illustrating additional functions of the DMAP system.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The media distribution system herein is generally configured to allow consumer access to digital media in a secure and/or controlled fashion via a local media access device. The media distribution system provides a digital media rental system, which allows a digital media provider to remotely connect to an end-user media access device to load the digital media content for a user. As used herein, media includes, but is not limited to, movies, music, videos, eBooks, digital news, concerts, sporting media, special event media, etc.

Media can be directly downloaded to the media access device at a predetermined time chosen by the user (subscription model). This allows users with lower bandwidth to take advantage of digital media services. Media can be chosen from an “app” that is loaded on any PC, laptop, portable smart device, tablet, smart phone, or other digital device that accesses the internet. The media distribution system may provide an application programming interface (API) to allow the user to access the content to be leased, rented, and/or purchased.

In addition, the media distribution system includes systems and methods for allowing media that is owned by the user of a media access device to be co-located (on the same device) as media that is owned by third parties. Security features of the media distribution system protect the interests of each party, prohibiting the other from accessing, copying, downloading, viewing, or otherwise connecting to the media without permissions being granted by the media's owner.

The digital media rental system allows a user to interact with one or more media providers to receive digital media (movies, music, eBooks, and other digital content). While other known devices provide a conduit to receive media in a similar fashion, the media access device herein differs significantly as will now be described.

In a typical movie or video rental scenario, a user will access a media provider from their internet ready TV or other portable internet device and browse the content offered by the provider. Once the content is chosen and purchased or rented, the content is made accessible for viewing and is streamed from the provider through the internet to the user's device. Streaming, commonly seen in the forms of audio and video streaming online (as used herein), refers to playing a media file without completely downloading the file first. The media may be buffered on a playback device while it is playing and downloading.

Once the media session is complete, the transaction ends. The media access device herein provides the capability of downloading multiple digital media files simultaneously, storing them for access at the user's convenience. In a similar manner to a movie rental model, the user can go to the online video store, choose multiple titles for viewing and have these titles delivered to the media access device. The rented or other purchased content is stored locally on the media access device for later use.

Traditionally leased or rented media is typically stored in cloud based or other online storage, but the media access device eliminates the need to store media remotely. A secondary function of the media access device is to allow temporary storage and management of media that is being leased or rented from a media provider (like Netflix™ or Blockbuster™). As will be described further below, the media access device provides separate and secure storage for rental media to ensure media security.

The media loaded to the media access device will typically be chosen from a media provider and be managed by a corresponding service agreement. A typical media provider service agreement allows users to pay a flat rate for a specific number of digital media rentals within a given period. As an example, we will assume 10 media rentals in a 30-day period. The user entering into the agreement will access the provider website and create a media list from which the provider will begin providing media directly to the user via the media access device as defined by this list. The user can manage their content list remotely from any of their internet ready devices. In this manner, media can be managed locally as well as remotely.

A key feature of the media access device lies in allowing the user to determine a time for the media to be delivered from the media provider to the media access device. This feature significantly improves user bandwidth optimization, and is particularly well suited for users with lower speed connections, which make streaming difficult, if not impossible. The user of the device can choose any time during the day or night for the delivery of the media to the device, allowing them to obtain it immediately or schedule the delivery of the media during non-peak usage hours, negating the need for higher bandwidth to enjoy the digital content.

Media rental or lease will now be described. It is noted that the user would create an account and/or login to a media provider website. Once at the media site, they create a list of media the user wishes to view for the given period (in this case, 30 days). Once the user has executed and completed the media agreements called for by the provider, they would choose a time of day in which the media would be delivered to their media access device.

At the predetermined time, the media provider would automatically access the media access device and begin downloading the media selections from the list created by the user. For this example, we will assume that the provider has agreed to allow the user to host or store three rental titles locally on their media access device at any given time.

The media would be loaded into the device in the sequestered and encrypted storage area of the media access device, limiting the user's options to those granted by the provider. These options would typically include, but are not limited to, play, rewind, pause, start, stop, fast forward, purchase, and delete. It is noted that the media access device may utilize various storage technologies now known or later developed, including magnetic, optical, or flash based storage.

The media would remain on the media access device for the time allotted, such as defined by the agreement entered into by the user and the media owner. Once the user has accessed and viewed the media, and indicated it should be deleted, it will be subsequently removed from the device, and be replaced by the next media selection from the user's list created and hosted on the provider site. The media access device will always host the minimum number of media titles (in this case three) giving the user a variety of choices, as opposed to the typical single movie streaming model. It will be understood that minimum numbers of media titles may be hosted on the media access device.

At any time within the media hosting arrangement, the user can choose to purchase a title from the media owner. Once the purchase has been completed, the media will be immediately removed from the sequestered storage portion of the device and relocated to a personal cloud portion of the device. This personal cloud portion is a media repository where the user keeps their personal digital content (i.e., the media the user owns), which may be managed through a media distribution system. Exemplary media distribution systems include StoAmigo™ (a cloud-based file management and storage system from Duvon Corporation), Dropbox™, Box™, SugarSync™, Google Drive™ and iCloud™.

Though described herein with regard to movies or television shows, it is noted that the media access device may handle music, eBooks, and other digital media that can be rented or purchased from digital media providers in the same fashion.

Another advantage of the media distribution system is that it provides security for the rented or leased media. As described briefly above, in operation the security feature may store digital content delivered to the device from a provider in a sequestered storage area on a media access device that is controlled and managed (at least partially) by the provider. This allows the provider to execute permissions or conditions for use or access that may be associated with the media. In this manner, the provider has complete control and ownership of the media, even while the media is being hosted on the user's media access device.

The media will typically be encrypted to ensure that the user cannot accidentally or otherwise access the media without express permission. A media owner can therefore choose at any time to remotely delete and/or otherwise block usage of the media as well. This is because the permission setting on the media being shared is based on the recipient of the share, as opposed to the media itself. With this permission based sharing, media can be managed without the need for passwords and other antiquated protection methods. Permissions are always controlled by the owner of the media, and can be changed and/or revoked at any time. This gives the media owner ultimate control over their media. Media can be taken back at any time, regardless of the content of the share, the user the share is tied to, or the media being shared.

In addition to the encryption methodology for protection of the media, the media access device also incorporates a multiple-partition approach on its storage device designed to prevent access to the media that is owned, managed, and controlled by the media provider. Having rented media stored on a separate partition within the storage device of the media access device adds a second layer of security, ensuring the media remains the sole property of the media owner.

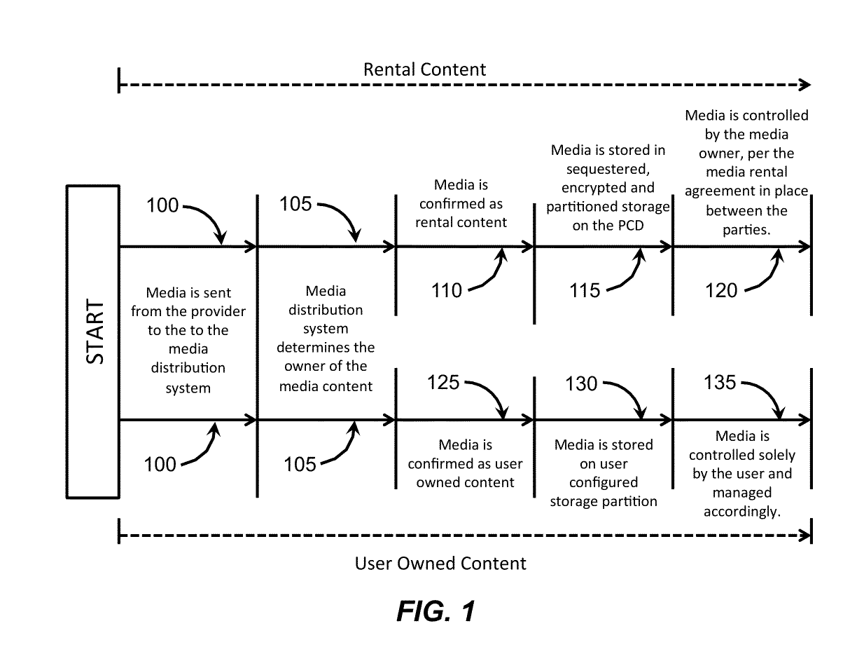

A typical scenario for media storage and access within the device will now be described with reference to the flow diagram of FIG. 1. At a step 100, rental media is sent from a media provider to the media access device. At a step 105, the media access device recognizes the content as leased or rented material, such as via an API, code identification, or other identification scheme provided by the media provider. If the media has been leased or rented, the identification process notifies the media access device that the material is not the property of the media access device's user at a step 110.

At a step 115, the media access device then routes the media to a secure partition or portion of the media access device's storage device for storage and access by the user. The media owner (in this case the media provider) maintains full rights of access, including removal and deletion of the media from the device and may control or change usage, access, or other rights/capabilities at a step 120. It is noted that while the media access device is storing the media for the user to access, it may also be encrypted to ensure that there is no way for the user to accidentally or otherwise gain access to the media without the express consent of the media owner.

As stated above, once the user is done with the media, it can either be purchased or removed from the media access device, thereby allowing the media provider to download another media selection from the user's list to the media access device, at the predetermined time defined by the user.

Referring to step 125, if the media is confirmed as user owned content, the media may be stored in a user partition on the media access device's storage device at a step 130. The user may then control or change usage, access, or other rights/capabilities to this user owned media at a step 135. It is understood that the storage can be (but is not limited to) a physical drive with dual (dedicated) partitions, one for the user and one for the provider, or completely separate physical drives.

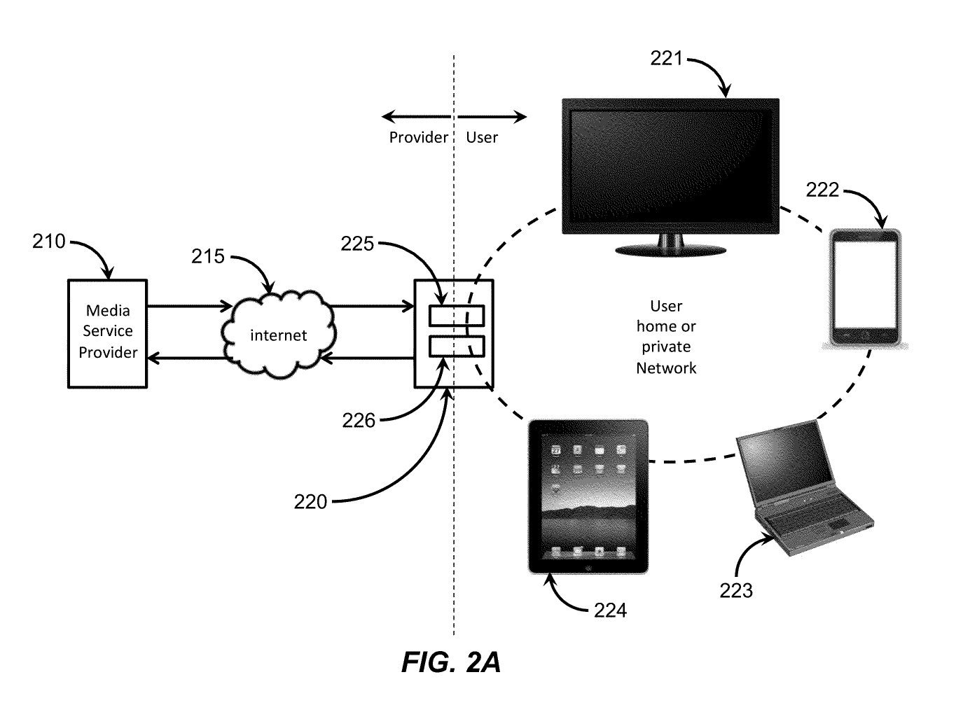

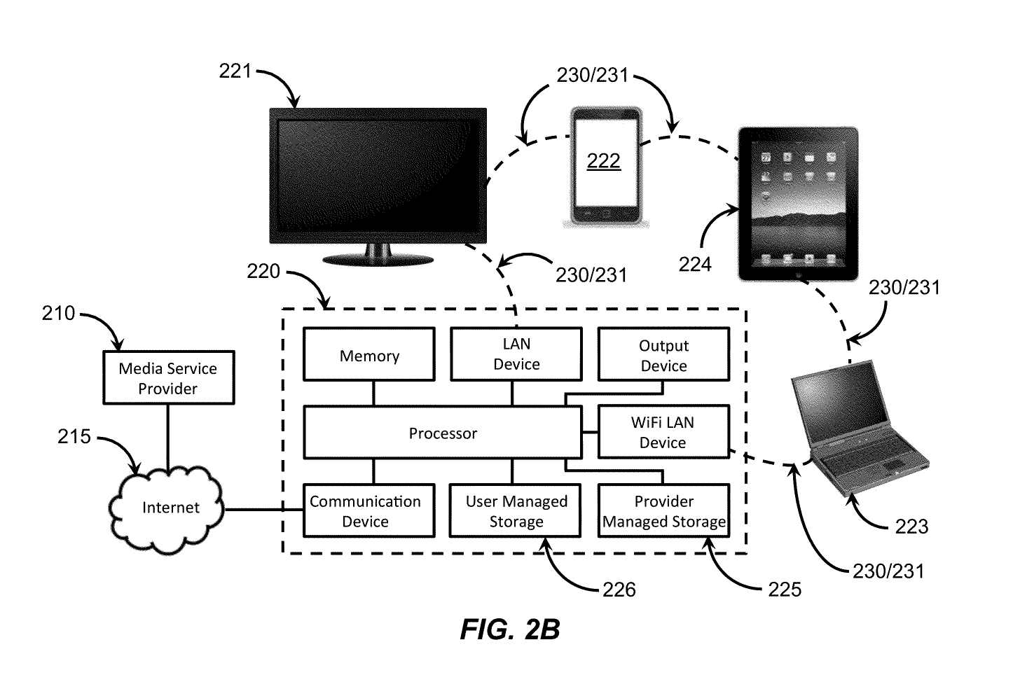

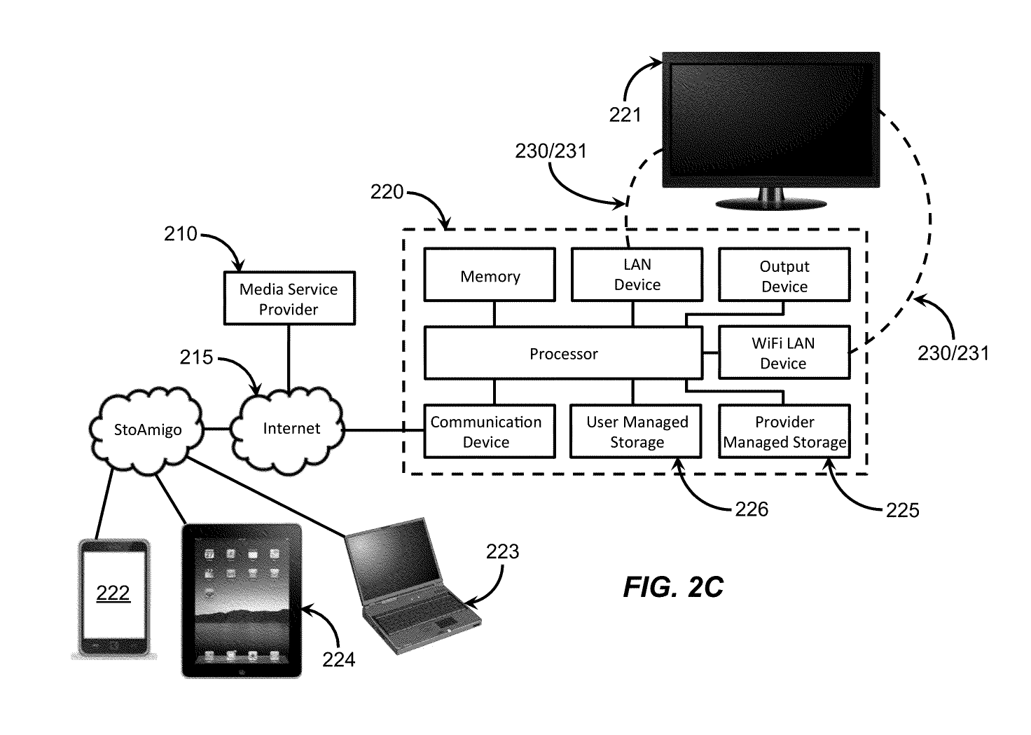

FIG. 2A is a block diagram illustrating an exemplary media distribution system 200. As can be seen, the media distribution system 200 may include one or more media access devices 220 connected to one or more media providers 210 via a network, such as the Internet 215. In one or more embodiments, the media access device 220 may be a network appliance or set top box type of device configured to operate as disclosed herein. Typically, the media access device 220 will include one or more wired or wireless communication devices to allow communication with a media provider 210 or other user devices (as will be described further below).

As can also be seen, the media access device 220 will typically be located at a user's premises, such as the user's home. The media provider 210, which may be a server or the like, may be remote from the media access device 220 and be in communication with the media access device 220 via the Internet 215 or other network.

The user may access (e.g., play) media hosted/stored on the media access device 220 from various client devices. As shown in FIG. 2A for example, the user may view or be presented media on the media access device 220 from a television 221, smartphone 222, laptop or other computer 223, or tablet 224. Typically, these devices will be on the same local network as the media access device 220. It is also noted that users incorporating devices like smartphone 222, laptop or other computers 223, and tablets 224 can access their media distribution system remotely (outside of their local area network (LAN) through a cloud service like StoAmigo. The user can access their cloud service from any available internet connection.

As described above, the user may host or store various media on the media access device 220. For security purposes, this media may be stored in various portions or partitions on a storage device of the media access device 220. As shown in FIG. 2A for example, a provider managed partition 225 and a user managed partition 226 are provided. The media provider 210 controls the provider managed partition 225 to retain control and ownership of its media even though the media access device is in the user's possession. Typically, rented or leased media will be stored in the provider managed partition 225, as described above. Similarly, the user controls the user managed partition 226, thereby allowing the user to control use or access of his or her media.

FIG. 2B is a detailed view of the media access device 220 in an exemplary environment of use. As can be seen, the user gains access to both the provider managed storage 225 and the user managed storage 226 from their local area wired 230 or wireless 231 local area network (LAN). As disclosed herein, the user can easily access and view the media hosted on either storage device within the media access device 220 from their TV 221, smartphone 222, laptop or desktop computer 223, and/or their tablet 224.

FIG. 2B also illustrates components of an exemplary media access device 220. As can be seen, the media access device 220 may comprise one or more processors communication devices, storage devices, and memory devices. One or more output devices, such as for outputting media to one or more client devices may optionally be provided. In general, an output device will directly provide an audio and/or video signal to a client device, such as a television 221, to present media thereon.

In general, a processor may be a microprocessor, controller, circuit or the like. In one or more embodiments, a process will be configured to control components of the media access device 220 to provide the functionality described herein. To illustrate, the instructions may be configured to segregate provider media and user media when stored and control access to the same as described herein. A processor may execute one or more instructions such as machine readable code to provide such functionality. It is contemplated that these instructions may be stored on a memory or storage device or may be hardwired into a processor. In some embodiments, the instructions may be stored on and retrieved from a non-transitory storage medium for execution by a processor.

A storage device may utilize various data storage technologies for reliably storing data thereon. For example, a storage device may be a magnetic hard drive, flash drive, or optical drive in one or more embodiments. Typically, the provider managed storage 225 and user managed storage 226 will be separate storage areas. It is contemplated that the provider managed storage 225 and user managed storage 226 may be separate storage areas or partitions on a single physical storage device or multiple storage devices.

Various communications devices may be provided as well. For instance, in the embodiment of FIG. 2B, the media access device 220 has a first communication device for communicating with a media provider 210 via a wide area network, namely the internet 215. The media access device 220 may also comprise one or more second communication devices for communicating via a local area network. In FIG. 2B for instance, the media access device 220 comprises a wireless LAN communication device as well as a wired LAN communication device. It is noted that one or the other or both may be provided in some embodiments.

In general, the second communications devices transmit media to one or more client devices on a local area network where the media may be presented/viewed by a user. To illustrate, it is contemplated that the local area network may be a local subnet at the user's location, such as the user's residence, office or the like. The first communication device may be used to receive media, such as rented or purchased media from a media provider 210, from a remote location via the internet 215 or other wide area network.

FIG. 2C illustrates how the user can access the provider managed content 225 as well as their own content 226 from any physical location that has an internet connection. The user can achieve this by first logging into their cloud storage provider (such as StoAmigo). The ownership of the media access device is then authenticated by the cloud storage system and remote access to the user device is granted. The user can now view, manage, and otherwise gain full access to the personal storage 226. The provider managed storage 225 will be governed by the terms of the user agreement in place between the media host and the user, but if the agreement allows remote access, the user will be able to view their rental content from anywhere they have internet access. This capability allows the user to freely view their media from home or on the road, providing ultimate accessibility to rented content.

The DMAP described herein is generally configured to enable a provisioner or owner to create, assign and manage partitions within a storage device such as a hard drive, flash drive or other digital storage facility. These partitions may be assigned to an individual, and may be reconfigured and/or reassigned anytime. Configuration parameters defining such partitions may be received locally, such as via a user interface device and GUI or remotely from a remote client device or DMAP system.

Further, the DMAP system allows a provisioner or owner to manage storage repositories internal to, or external to the system in which the DMAP is deployed. The provisioner may choose to assign an entire drive to a single user or to a group of users, or to partition the drive in any configuration deemed necessary for the given application. A provisioner may be a user or a media provider in one or more embodiments.

A provisioner may assign themselves to a specific partition or to a specific drive, and may remove themselves as well. It is not required that the provisioner participate in utilization of the drives managed through the DMAP system.

The DMAP does not require the drive being provisioned to be local to the host system. Specifically, a host (such as a PC, a server, media access device, a Secured Media Distribution System or other computing device) may utilize the DMAP to provision storage repositories that are remotely accessible to the host system.

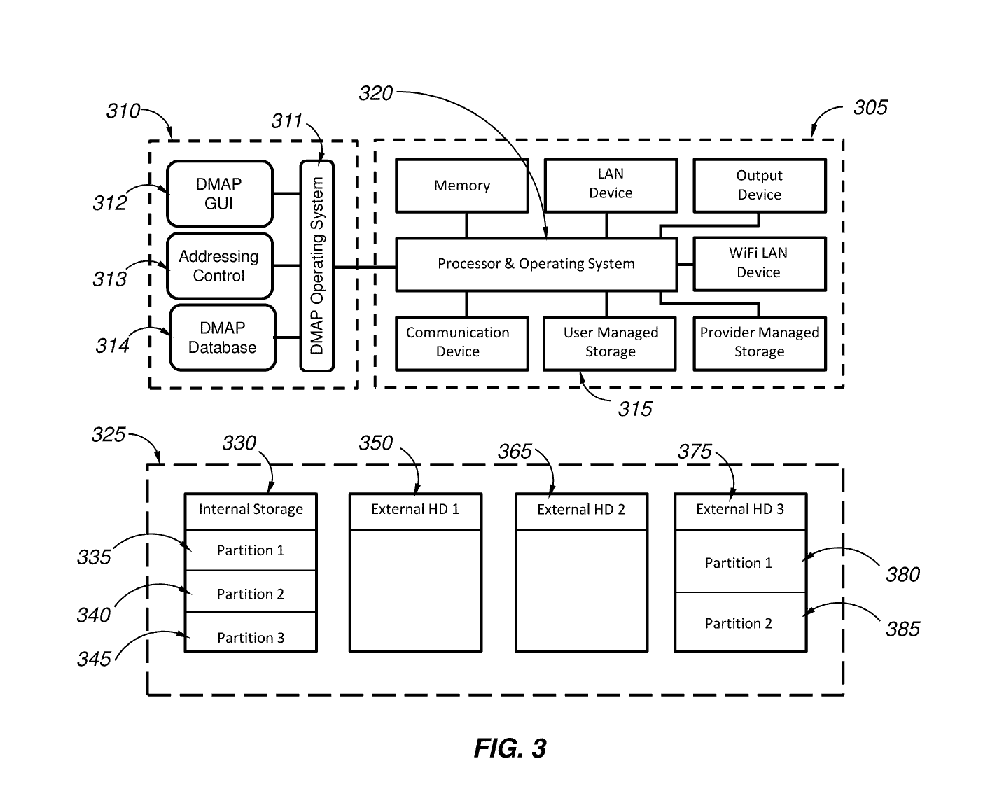

An architectural drawing of the primary components of the DMAP as it is utilized within the Secured Media Distribution System will now be described with reference to FIG. 3. The primary components of the DMAP 310 system are the operating system 311, the graphical user interface 312, the addressing control module 313 and the database module 314.

In a typical deployment of the DMAP system (as is the case in the Secured Media Distribution System 305, or “host system”), the DMAP operating system 311 is provisioned to interface with the host system 305 through the host system processor and operating system 320. The provisioning includes coding and other language required to enable the DMAP 310 to engage with the components and systems required to control the storage repository (in this case, the user managed storage 315) of the host system 305.

A visual representation of the command, feature and configuration set(s) are provided to the provisioner through the graphical user interface 312 of the DMAP system 310. The graphical user interface 312 provides the provisioner with a detailed menu of controls (covered later in this submission) that govern the storage repository (user managed storage 315) provisioning.

The addressing control module 313 interfaces with the operating system 311, the GUI 312 and the database 314 to enable the provisioner to create and manage the addressing assignments required to govern the user managed storage 315. The database 314 module stores the provisioning information set through the GUI 312, and provides controls to govern access to the storage repositories (user managed storage 315) as configured by the provisioner. All access permissions, user information and other criteria for storage access is controlled and managed by the database 314.

The lower half of FIG. 3 shows reference 325. Reference 325 is an example of how the DMAP 310 may configure the user managed storage 315 provided by the host system 305. While the example shown in FIG. 3, reference 325 depicts four storage repositories (330, 350, 365 and 375), it's important to note that there is no limit to the number of internal or external storage devices that the DMAP 310 system can manage. Further, any number of users or user groups may be assigned to any storage managed within the DMAP 310 system.

For the purpose of the example depicted in FIG. 3, we are assuming the host system 305 (containing the DMAP 310) has been deployed at a private residence. The storage configurations will be dedicated to family members and extended family members as explained below.

As can be seen in FIG. 3, reference 325, the provisioning of the user managed storage 315 shows an internal storage 330. The internal storage 330 is being used by the owner of the host system 305 for storage and data management for their immediate family (not shown). The owner has provisioned partition one 335 and assigned it to a first family member (his spouse). The owner has further provisioned partition two 340 for a second family member (his son), and partition three 345 for a third family member (his daughter). At this point in the provisioning of the internal storage 330, the primary partitioning of the storage have been completed and may be utilized by the assigned family members.

The owner of the host system 305 has also attached an external hard drive 350 to the host system 305. The owner has assigned this external hard drive 350 to be used as his own personal drive, and therefore has designated himself as the single user, and no partitioning is necessary as the owner will have access to the entire storage contents of the drive.

The owner of the host system 305 has attached a second external hard drive 365 to the host system 305. The owner has chosen to assign this drive to a first extended family member (his brother) to allow his brother to participate in the media sharing and storage of the host system 305. Since the second external hard drive 365 is assigned only to his brother, no further partitioning is necessary, and his brother will have access to the entire allotment of storage space provided on second external hard drive 365.

The owner of the host system 305 has attached a third external hard drive 375 to the host system 305. The owner has chosen to assign this drive to a second and third extended family member, his brothers' children (his niece and nephew). The owner has assigned partition one 380 to a second extended family member (his niece) and partition 385 to a third extended family member (his nephew).

In the above example, the owner of the host system 305 has successfully configured his system to allow members of his immediate and extended family to engage in, and utilize the storage repositories 330, 350, 365, 375 connected to his secured media distribution system 305 (host device). It's important to note that these configurations as provided above may be changed and/or reassigned at any time, or eliminated completely. As will be explained later in this submission, the partition sizes may be varied depending on the needs of the configuration being set, in conjunction with the allotted space provided within the storage repository.

The DMAP will detect any storage repository attempting to interact with the host system 305 and query the owner of the system to determine if/how the storage repository will be allowed to interact with the host system. The connection, provisioning and assignment of storage repositories managed by the DMAP will be discussed in detail later in this submission.

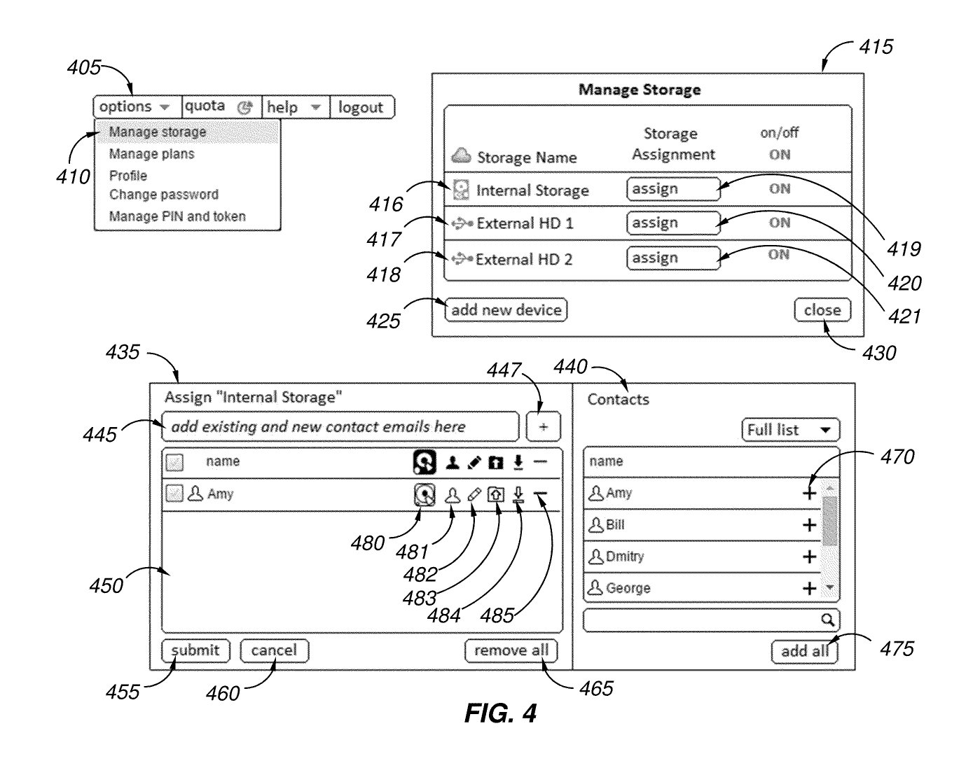

The DMAP system provides detailed controls and configuration parameters that allow the system to manage and control internal and external media devices and/or partitions assigned through the system. A typical configuration menu for assignment and partitioning of storage repositories will now be described with reference to FIG. 4. The menu representations seen in FIG. 4 are configured to support the Secured Media Distribution System, but can be configured for deployment within any system that provides a storage repository. These systems include (but are not limited to) personal cloud storage devices, internal and external hard drives, personal media servers, personal computers and other storage-centric devices.

Referring to FIG. 4, an options menu 405 within the Secured Media Distribution System (not shown) is accessed by the provisioner. Once accessed, the provisioner may enter the DMAP manage storage menu 410. Actuating the manage storage 410 menu opens a new window 415 (Manage Storage) to enable the provisioner to manage the storage components of the DMAP system.

The Manage Storage 415 window shows the currently available storage repositories that are associated with the Secured Media Distribution System, and available for provisioning through the DMAP. In the example shown, the Manage Storage 415 window shows an internal storage 416, and external hard drive 1 417 and external hard drive 2 418. The provisioner may choose to provision any of these drives (referenced above), or may choose to add a new device 425.

Each drive 416, 417, 418 has an assign button 419, 420, 421 respectively assigned to it to enable the provisioner to assign the designated storage repository to a user or group of users. The Manage Storage window 415 also provides a close 430 button to exit the Manage Storage 415 screen and return to the previous menu option 405.

For the purpose of this example (continuing to refer to FIG. 4), we will provision the internal storage 416 drive shown on the Manage Storage 415 window. The provisioner will select the internal storage 416 drive by actuating the assign 419 button associated with the drive. Once actuated, a new window 435, showing the title “Assign Internal Storage” will appear. The title on the window 435 will always be associated with the drive selected on the Manage Storage 415 window.

To add a user to the selected drive (internal storage 416), the provisioner can enter their email address into the “add existing and new contact” 445 window, and actuate the “plus” 447 icon, or the provisioner may select a contact from the contact list 440 by navigating to the required contact and selecting the plus 470 sign next to the desired contact. Once the user has been selected (in this example, we have selected Amy), their name will appear in the user area 450 on the left side of the screen. The provisioner may choose to add all of the users on a contact list 440 by selecting the “add all” 475 button.

Once the provisioner has completed selecting the users for a specific drive, they may now choose permission settings for access for that particular user, or for the entire group of users. The DMAP system provides permission settings to govern drive partition assignments 480 (discussed later in this submission) as well as permissions to govern sharing 481, editing control 482, uploading new content to the drive 483, downloading content from the drive 484, or removing the user from accessing the drive 485.

As can be seen in FIG. 4, the Assign Internal Storage 435 window enables a provisioner to provide different permissions to each individual user assigned to the drive, or to give each user the same access. It's important to note that a provisioner can enter the menu for the DMAP and change these settings and assignments at any time. There is no restriction to drive access for the provisioner.

Once the provisioner has entered all of the user information and permission criteria, they can save their settings by selecting submit 455. If the provisioner chooses to exit without saving these selections, they can select cancel 460 which will return them to the manage storage menu 415. Further, selecting remove all 465 will delete all user and permission settings from the drive, allowing the provisioner to start the provisioning and assignment session from the beginning.

The DMAP provides a high level of management and control over storage repositories. As stated previously, a storage device may utilize various data storage technologies for reliably storing data thereon. For example, a storage device may be a magnetic hard drive, flash drive, or optical drive in one or more embodiments. Further, these storage repositories may be physically located as an internal component to the host system, or may be remotely connected to the DMAP either through wired or wireless connection. There is no provision requiring the storage repository to be collocated with the DMAP.

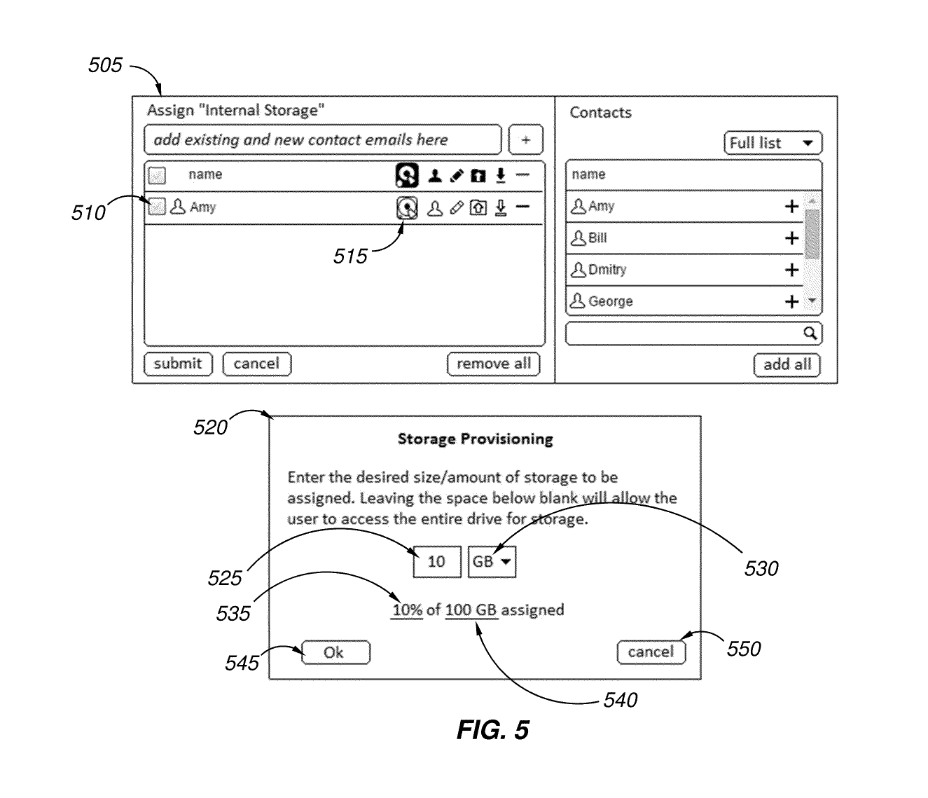

As stated previously, the DMAP allows the provisioner to assign a specified amount of storage space on a given storage repository or drive to an individual, or to a group of users. The assignment of storage space will now be discussed with reference to FIG. 5.

Referring to FIG. 5, the provisioner has navigated to the Assign Internal Storage 505 menu (as we discussed previously in FIG. 4). In this example, the provisioner will assign user 510 (Amy) a specific amount of storage space utilizing the storage management icon 515. Upon selecting the storage management icon 515, the storage provisioning window 520 will appear. The storage provisioning window 520 allows the provisioner to enter the desired amount of storage space 525 to be allotted to the user. The storage space may be provided in megabytes, gigabytes or terabytes using the pull down menu selection 530. As the provisioner selects the desired amount of storage space 525, an active reporting 535 of the percentage of total storage assigned will be shown, as will the total amount of storage 540 in the referenced size (megabytes, gigabytes or terabytes) 530. The provisioner may choose to leave the selection 525 blank, allowing the assigned user to access the entire drive storage space (in this case 100 GB 540) as their storage.

It is not necessary for a provisioner to select an amount of storage space for any user, or any group of users. Leaving the selection 525 blank for all users will allow them to utilize the drive entirely, until the storage space (in this case, 100 GB 540) is exhausted. Once the provisioner has made their selections, they can select ok 545 to accept them and close the window 520, returning them to the previous menu.

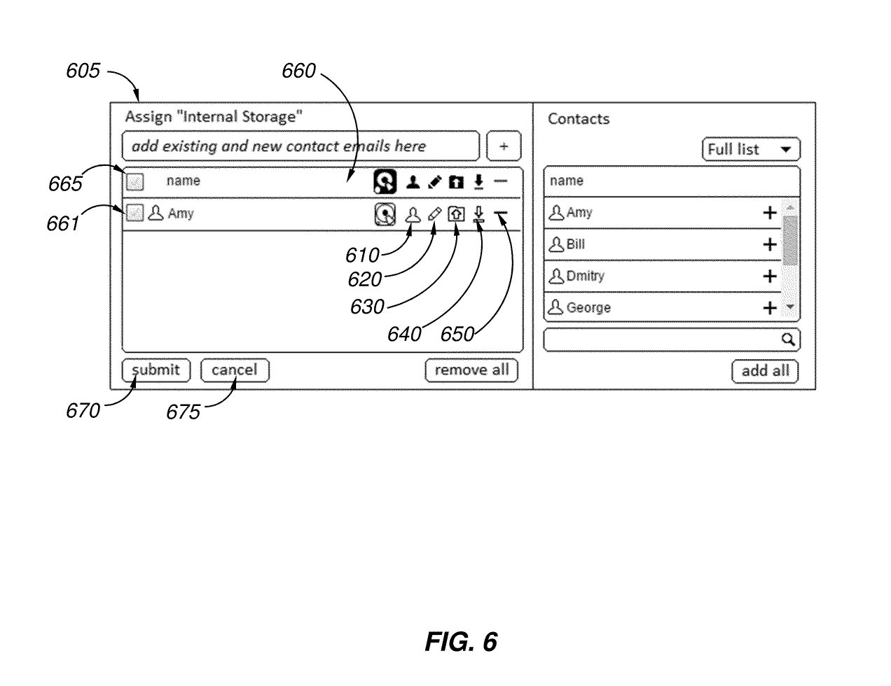

The DMAP provides additional features and functions to further enhance the management capabilities that a provisioner can use to govern access and utilization of the storage repository being provisioned with the DMAP system. These additional functions governing user permissions managed by the DMAP will now be discussed with reference to FIG. 6. It's important to note that while additional permission settings within the system exist, other more commonly available features and functions have been eliminated to provide clarity to the current submission.

As can be seen in FIG. 6, the provisioner (not shown) has accessed the Assign Internal Storage 605 window through the menu configurations discussed previously in this submission. From the Assign Internal Storage window 605, The provisioner can manage sharing 610, editing 620, file and folder upload 630, download 640 and removal of a user 650. The icons shown 610, 620, 630, 640, 650 can be used to manage an individual user (in this example, Amy), while the corresponding icons above in the “name” line 660 can be used to manage multiple users when setting like permissions for multiple people. To select one or more users to share like provisioning settings, the provisioner can select the check box 665. Once a check mark appears in that box (not shown), it may be managed using the master set of provisioning icons in the “name” line 660. Adding a check to the box in the “Amy” line 661 (as an example) would enable her unique individual provisioning settings 610, 620, 630, 640, 650) to be managed with the master set of provisioning icons 660.

The sharing icon 610 may be enabled/disabled to determine if the user assigned to the drive (in this example, Amy 661) is allowed to share any of the contents of the partition or drive with others. A “hollow” icon (as shown in 610) serves as an indication that sharing for the current user (Amy) has been disabled. The provisioner can toggle sharing 610 icon to enable or disable this feature. As an icon becomes dark (as shown with the corresponding master icon 660 directly above the sharing icon 610), it serves as an indication that the specific setting is toggled to enable.

The edit icon 620 may be enabled/disabled to give the assigned user rights to create new folders, edit existing folders and/or content, and to remove digital content stored on the drive. As with the sharing icon 610, the hollow icon 620 indicates the edit feature is currently disabled.

The upload icon 630 indicates the assigned users' rights to upload and/or add new folders and other digital content to the assigned drive. As with all other permission settings, the upload 630 permission may be enabled/disabled by the provisioner at any time.

The download icon 640 indicates the assigned users' right to download or otherwise take possession of content that is stored on the assigned drive. The download icon 640 may be toggled to enable or disable the download feature for the specific user. Here again, this may be changed at any time, or may be managed by the master icon set 660 when the user 661 (Amy) is selected as part of a larger user group.

The final icon 650 is the “minus” sign icon. This icon 650 allows a provisioner to remove a single user by actuating 650, or multiple users when used in conjunction with the master icon set 660 and the check box for the user Amy 661.

The permission icons 610, 620, 630, 640,650 are provided within the DMAP to give the provisioner advanced controls over individual users, or groups of selected users. As stated previously, when the icons are toggled to the “on” or “enabled” setting, they will appear darkened or filled in, while in the “off” or “disabled” state, they will appear hollow as shown in icons 610, 620, 630, 640 and 650.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A media access device comprising:
one or more storage devices having a plurality of storage partitions, wherein the plurality of storage partitions are defined by configuration parameters;
one or more databases storing a plurality of user groups, each of the plurality of user groups comprising one or more user accounts and associated with a distinct one of the plurality of storage partitions;
one or more communication devices that receive a plurality of files from users; and
one or more processors that, for each file in the plurality of files:
identify the user that transmitted the one or more files;
identify a user group in the plurality of user groups to which the identified user belongs; and
store the file in the distinct one of the plurality of storage partitions associated with the identified user group;
wherein at least two of the plurality of files are received from users in different user groups.

2. The media access device of claim 1, wherein the configuration parameters are received from one or more of the users.

3. The media access device of claim 1, wherein the one or more databases store upload permissions associated with a subset of the plurality of user groups.

4. The media access device of claim 3, wherein the file is stored only if upload permissions are associated with the identified user group.

5. The media access device of claim 1, wherein the one or more databases store download permissions associated with a subset of the plurality of user groups.

6. The media access device of claim 5, wherein the one or more communication devices transmit one or more files to the identified user from the distinct one of the plurality of storage partitions associated with the identified user group if download permissions are associated with the identified user group.

7. The media access device of claim 1 further comprising a user interface, wherein the configuration parameters are received via the user interface.

8. A media access device comprising:
one or more storage devices comprising a first partition and a second partition, wherein the first storage partition and second partition are defined by configuration parameters;
one or more databases storing a plurality of user groups, the plurality of user groups comprising a first group and a second group;
one or more communication devices that receive one or more files; and
one or more processors that:
determine if the one or more files are from a user in the first group or the second group;
store the one or more files in the first partition if the user is in the first group; and
store the one or more files in the second partition if the user if in the second group.

9. The media access device of claim 8 further comprising one or more user interfaces, wherein the configuration parameters are received via the one or more user interfaces.

10. The media access device of claim 8, wherein the configuration parameters are received via the one or more communication devices.

11. The media access device of claim 8, wherein the one or more databases store upload permissions associated with a subset of the plurality of user groups.

12. The media access device of claim 11, wherein the one or more files are stored only if the user is in a group having the upload permissions associated therewith.

13. The media access device of claim 8, wherein the one or more communication devices transmit the one or more files stored on the first partition to the user upon receipt of a download request, if the user is in the first group.

14. The media access device of claim 8, wherein the one or more communication devices transmit the one or more files stored on the second partition to the user upon receipt of a download request, if the user belongs to the second group.

15. A method for providing media with a media access device comprising:
receiving configuration parameters defining a plurality of partitions, the plurality of partitions comprising a first partition and a second partition;
partitioning one or more storage devices according to the configuration parameters;
storing a plurality of user groups in one or more databases, the plurality of user groups comprising a first group and a second group;
receiving one or more files via one or more communication devices;
determining if the one or more files are from a user in the first group or the second group;
storing the one or more files in the first partition if the user is in the first group; and
storing the one or more files in the second partition if the user if in the second group.

16. The method of claim 15, wherein the configuration parameters are received via the one or more communication devices.

17. The method of claim 15 further comprising presenting a user interface via a display device, wherein the configuration parameters are presented for selection via the user interface.

18. The method of claim 15 further comprising associating upload permissions with a subset of the plurality of groups.

19. The method of claim 18, wherein the one or more files are stored only if the user is in a group having the upload permissions associated therewith.

20. The method of claim 15, wherein the first partition is a provider partition and the second partition is a user partition.
